(19) United States
(12) Patent Application Publication
(10) Pub. No.: US 2013/0254747 A1
(43) Pub. Date: Sep. 26, 2013

(54) METHOD AND APPARATUS FOR TESTING PROGRAMS

(71) Applicant: Daniel Citron, Haifa (IL)

(72) Inventor: Daniel Citron, Haifa (IL)

(73) Assignee: International Business Machines Corporation, Armonk, NY (US)

(21) Appl. No.: 13/425,431

(22) Filed: Mar. 21, 2012

(51) Int. Cl. G06F 9/44

(52) U.S. Cl. 717/126

(57) ABSTRACT

A method and apparatus for testing a computer program for correct execution by various computerized apparatuses, the method comprising: obtaining at least two configurations for a computing platform; for each configurations of the at least two configurations: setting the computing platform in accordance with the configuration; and executing a computer program on the computing platform using the configuration, thereby testing the computer program for correct execution by various computerized apparatuses.

### TECHNICAL FIELD

The present disclosure relates to testing programs in general, and to a method and apparatus for testing software in various processor settings in particular.

### BACKGROUND

Computerized devices control almost every aspect of our life—from writing documents to controlling traffic lights. However, computerized devices are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized device, such as a medical device, a traffic light, or others. Additionally, a bug in hardware or firmware of a marketed product may be expensive to fix, as patching it may require call-back of the computerized devices from the market. Hence, many developers of computerized devices invest a substantial portion of the development cycle in discovering erroneous behaviors of the computerized device.

A specific problem in testing relates to testing programs or other software components in various hardware environments, including different number and types of processors, threads, different cache sizes, memory and disk configurations, or the like. Programs may behave differently in multi-processor or multi-thread configurations, or in other differing environments, such that bugs that are not present or not revealed in one configuration may exist or be revealed in another configuration. It may thus be insufficient to test a program in one or more configurations, wherein the program may be later used in a different configuration.

However, maintaining a large number of computing devices having different configurations has significant monetary costs, consumes real estate, and is difficult to maintain. In addition, it is impractical to cover all expected and unexpected computer configurations. Moreover, even if these configurations are available for testing, testing the program in all possible environments requires significant scheduling and management resources.

Some solutions change the scheduling of multi-threaded programs. However, these solutions refer solely to the multi-threading aspect of configurations. In addition, such solutions are limited to specific development environments and programming languages. Moreover, such solutions may insert additional commands into the program under test, which may introduce new bugs.

### BRIEF SUMMARY

One exemplary embodiment of the disclosed subject matter is a computer-implemented method performed by a computerized device, comprising: obtaining two or more configurations for a computing platform; for each of the configurations: setting the computing platform in accordance with the configuration; and executing a computer program on the computing platform using the configuration, thereby testing the computer program for correct execution by various computerized apparatuses.

Another exemplary embodiment of the disclosed subject matter is an apparatus having a processing unit and a storage device, the apparatus comprising: a configuration generation component for determining two or more configurations for a computing platform; a configuration setting component for setting the computing platform in accordance with one of the configurations; and a data and control flow management component for initiating setting the computing platform in accordance with the one configuration, and initiating execution of a computer program on the computing platform using the one configuration, thereby testing the computer program for correct execution by various computerized apparatuses.

Yet another exemplary embodiment of the disclosed subject matter is a computer program product comprising: a non-transitory computer readable medium; a first program instruction for obtaining two or more configurations for a computing platform; a second program instruction for setting the computing platform in accordance with each of the configurations; a third program instruction for executing a computer program on the computing platform using the configuration, thereby testing the computer program for correct execution by various computerized apparatuses, wherein said first, second and third program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart of steps in a method for automatic testing of a program in multiple configurations, in accordance with some exemplary embodiments of the disclosed subject matter; and

FIG. 2 shows a block diagram of components of an apparatus for automatic testing of a program in multiple configurations, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block or blocks of block diagrams.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is that since a program or another software component may exhibit a bug in one computer configuration and not exhibit the bug on another configuration, it may be required to test the program on multiple computing platform configurations.

For example, many computer applications are multi-processed or multi-threaded, where in some systems multi-process and multi-thread may be implemented in the same way, and in some programs the differences may not be relevant to the problem solved by the program. In a multi-threaded environment the threads may communicate with each other via a myriad of methods such as shared memory, sockets, files or others, and in accordance with different protocols. Correct execution of the problem depends on synchronization between the threads, in particular when accessing shared resources. A serial program generally executes deterministically on a given input. However, due to timing issues between threads, a parallel program may run correctly on a given input, yet fail on the next run on the same input. For instance, thread A may write into a file which thread B reads from. The programmer may have assumed that thread A always writes before thread B reads, which was true in the development environment used by the programmer. However, when the program is tested on a different computer, for example at the client's site, the program may fail because thread A executed slower than thread B, and thread B did not verify that the file existed and contained valid data prior to reading.

It will be noted that testing the application on multiple computer systems may not be a desirable solution. For example, such a task may be expensive or even impractical in terms of the cost of hardware, real estate, maintenance and other costs, and may require complex administration to ensure the program is executed on all relevant environments.

Some known techniques simulate different behaviors of one or more threads using commands inserted into the application, for example commands for introducing different delays to threads. However, this does not ensure testing all the parameters that can differ between configurations, and in addition may introduce additional bugs.

One technical solution comprises the automatic modification of processor parameters and in particular hardware parameters of the computing device on which the tested software is to be executed, wherein the parameters may be set by software or may be set automatically in a different manner. The hardware parameters may include but are not limited to any one or more of the following: number of processors, number of threads per processor, priority of each thread, enabling or disabling pre-fetch, cache size, page size, or the like.

The tested software is then executed on the computing device for each such set of parameters or characteristics. The software is thus tested for correctness with respect to a multiplicity of configurations, each can be thought of as simulating different computing platforms, and different behaviors may be exposed. If the program executes correctly on all the configurations it can be assumed with a higher degree of confidence that it is bug-free, relative to traditional testing on one or few available configurations.

For example, certain attributes of some processors can be controlled by software. For instance, in the Power™ Instruction Set Architecture (ISA) the Simultaneous Multi-Threading (SMT) level of a processor core can be changed. A Power7™ processor contains eight cores, each of which can execute four threads. Thus, a maximum of 32 threads can run simultaneously. By changing the level of SMT on a core, the number of threads executed simultaneously can be altered between 1 and 32, which may change the timings of the threads. Other attributes that can be changed include the priority of each thread, thus effectively causing some threads to run slower; the default page size which will cause more or less page faults and thus change the timing of an application; enable/disable of automatic pre-fetching; effectively reducing cache size by locking data into some cache lines; the page size, or others. In some processors, for example in the x86™ ISA it is also possible to alter a processor speed by lowering its voltage and disabling caching.

In some embodiments, the used cache size can be changed. Multi-threaded programs sometime communicate via shared memory. Thus, it is common that two or more threads read and write the same variable. Correct execution of a program may depend on the programmer enforcing order on the access and update of these variables, wherein failure to do so may cause program failure. However, a faulty program may sometime execute correctly if the variable copies are in the caches which are physically next to the processing core and implemented in SRAM (L1 caches) and are updated quickly. By locking cache lines, i.e., storing data in the cache even if it is not used by the program and now allowing the data to be replaced, the effective size of the L1 cache on the processor may be reduced.

In some embodiments, various configurations may be created, and the program may be executed on any number of the configurations. After each execution, if the program failed it may be debugged. If it succeeds, the next configuration may be simulated by changing configuration parameters, and the program may be executed using the updated configuration. The configurations may be created or enumerated up front, or on the fly such that each configuration is created after the software has been tested on another configuration.

If the program fails on any one or more of these configurations, the bug may be further explored. If the bug occurs on one or more configurations and does not occur on others, it may provide a hint to the programmer what the bug may be related to. This information may be used by the programmer for debugging the program.

One technical effect of the disclosed subject matter relates to a method and apparatus for testing a program or another executable component on different hardware configurations of computing devices, without executing the program on different physical devices, and by changing only those characteristics of the computing devices that can be changed by software.

The disclosed subject matter provides for more thorough testing as related to different configurations, without the burden of purchasing and maintaining different devices, and without the management complexity associated with executing on multiple devices.

The method and apparatus provide for changing any parameter, including hardware parameter, which is accessible by software, whether directly by setting its value or by otherwise manipulating it, and testing the software for any configuration comprising one or more such parameters.

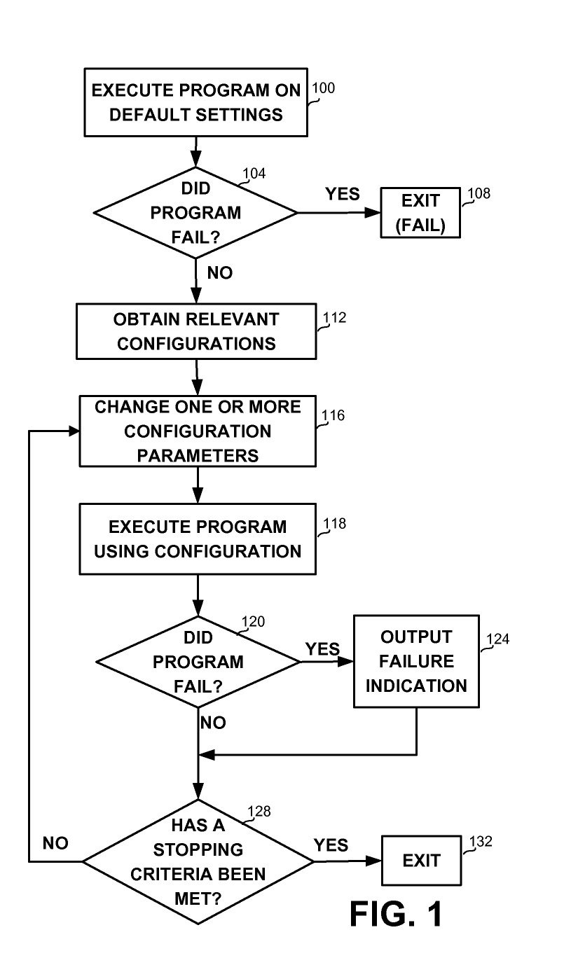

Referring now to FIG. 1, showing a flowchart of steps in a method for automatically testing software on multiple hardware configurations using a single computing device.

On step 100 the program may be executed on a default setting, such as the developer's computer, on a preferred computing platform configuration assumed to be available to most users or the like.

On step 104 it may be determined if the program executed on step 100 failed. This can be determined by examining an error code, examining the program's output, checking for exceptions, or the like.

In some exemplary embodiments, the output of the program may be compared with predetermined expected correct output and any deviation from the expected output is indicative of a bug. Additionally or alternatively, the output of different executions of the program (i.e., using different configurations) may be recorded and used as to compare the following executions. Different outputs may be indicative of a bug in one of the executions. In some exemplary embodiments, it may be determined which execution has failed in view of the number of executions that provided the different outputs. For example, if one execution provides output X, while ten other executions provide output Y, it may be determined that the execution has failed. As another example, if ten executions provide the output X and ten executions provide the output Y, it may be assumed that both outputs are legal and result due to non-deterministic aspects of the program, such as concurrency. In some exemplary embodiments, based on statistical analysis of the outputs, it may be determined whether each execution exhibited a bug. For example, in case the output was seen less than in a predetermined percentage of the executions, such as ten percent, it may be determined that the output exhibits a bug. Other statistical analysis methods, such as relating to distribution of the outputs, may be utilized as well.

If the program failed then on step 108 the method may exit with a failure notification. In some exemplary embodiments, the tested program may be debugged, either manually or automatically.

It will be appreciated that steps 100, 104 and 108 may be omitted in advanced stages such as system testing, integration, or the like, after the program has been tested on some default testing and believed to function as expected.

If the program passed, then on step 112 the collection of configurations relevant for testing may be determined or otherwise obtained. The configurations may include indications for any one or more of the changeable parameters related to the computing device upon which the program is to be tested, including but not limited to number of processors, number of threads per processor, priority of each thread, enabling or disabling pre-fetch, cache size, page size, or others.

The configurations may be created to cover all possible configurations, some representative configurations, for example testing for thread A having priority X and thread B having priority Y but not the other way around, or the like. The configurations may also be created in an orthogonal manner, for example testing all possibilities of a first parameter or parameter set with a second parameter or parameter set being fixed, and then testing all possibilities for the second parameter or parameter set with a single configuration for the first parameter or parameter set. In some embodiments, some parameters may be indicated as more important than others, such that more of their possible values are tested relatively to other parameters. In some embodiments, the configuration collection may be limited in size, such that at most a predetermined number of configurations are to be created.

On step 116 one or more configuration parameters are changed to configure the computing device on which the program is to be executed, in accordance with the configuration. The parameters may be set directly, for example by setting a registry entry, an environment variable, or the like. Other parameters may be changed indirectly. For example, the cache size can be effectively changed by calling a utility that uses assembly instructions to lock data into some of the cache lines, thus leaving fewer lines for the actual processing.

On step 118 the program is executed on the computing device having the updated configuration. In some exemplary embodiments, execution of the program by the computing device having the updated configuration simulates execution by a designated computing device.

On step 120 it may be determined if the program executed on step 118 failed. Examining whether the program has failed may be performed in a similar manner to that described in step 104.

If the program failed then on step 124 the method may output a failure notification, such as writing into a file, performing an action, or the like. The failure notification may also comprise available any information such as error codes, memory image, or the like, which may provide more input for later debugging.

It may then be determined on step 128 whether a stopping criterion has been met. The stopping criterion may relate to the previous execution having failed, an error was discovered, the program issued an error indication or the like, to the program having been tested on all configurations as created on step 112, whether a predetermined number of executions has been reached, whether a predetermined execution time has passed, or any other stopping criteria.

If the stopping criterion has been met then on step 132 the method may exit. If no failure indication has been output on step 124 for any configuration, the method may exit with a success indication.

If the stopping criterion has not been met, then execution may return to step 116, the computing device may be set to assume another configuration and the program may be executed again.

It will be appreciated that step 112 can be omitted and the configurations can be generated on the fly, such that after the program executed successfully for a particular configuration, the next configuration is determined. If creating all configurations is omitted, then only a first configuration may be determined on step 112, and each additional configuration may be determined upon returning from step 128 to step 116.

It will also be appreciated that the method of FIG. 1 can be implemented by a computer program or script that sets the computing device to the required configurations and executes the program. The computer program may be implemented to have a graphic user interface which may let the user provide indications for the required parameters and their values or settings, and which may provide visual or other indications for the progress and status of the testing process. In other embodiments, the method may be implemented as a command line program, as a background process, or the like.

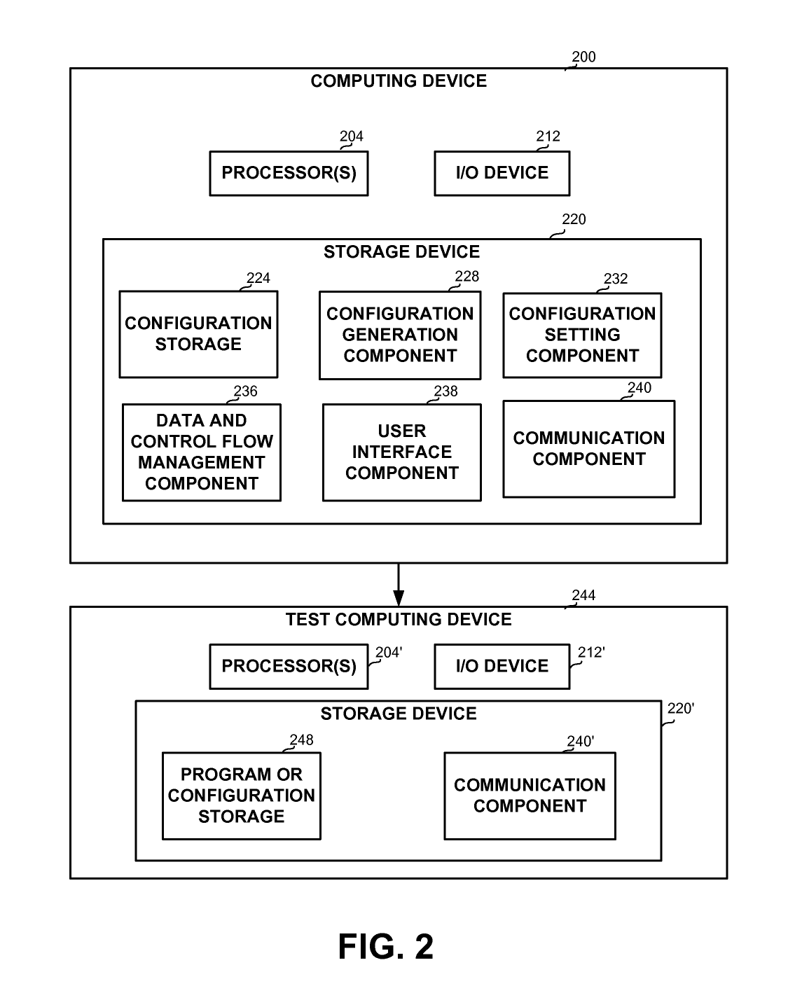

Referring now to FIG. 2, showing a block diagram of components of an apparatus for testing transactions.

The environment comprises a computing device 200, which may comprise one or more processors 204. Any of processors 204 may be a Central Processing Unit (CPU), a microprocessor, an electronic circuit, an Integrated Circuit (IC) or the like. Alternatively, computing device 200 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 204 may be utilized to perform computations required by computing device 200 or any of its subcomponents.

In some embodiments, computing device 200 may comprise an input-output (I/O) device 212 such as a terminal, a display, a keyboard, an input device or the like to interact with the system, to invoke the system and to receive results. It will however be appreciated that the system can operate without human operation and without I/O device 212.

Computing device 200 may comprise one or more storage devices 220 for storing executable components, and which may also contain data during execution of one or more components. Storage device 220 may be persistent or volatile. For example, storage device 220 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 220 may retain program code operative to cause any of processors 204 to perform acts associated with any of the steps shown in FIG. 1 above, for example determining configurations, setting a configuration, executing the tested program, or the like.

The environment may further comprise a test computing device 244 upon different configurations of which the program is to be tested. Test computing device 244 may comprise one or more processors 204′, I/O devices 212′ or storage devices 220′, similar to those detailed for computing device 200.

Storage device 220 may comprise one or more configuration storage areas 224 for storing the configurations, upon which the program is to be tested, or instruction or executable code for setting such configurations.

The components detailed below may be implemented as one or more sets of interrelated computer instructions, loaded to storage device 220 and executed for example by any of processors 204 or by another processor. The components may be arranged as one or more executable files, dynamic libraries, static libraries, methods, functions, services, or the like, programmed in any programming language and under any computing environment.

In some embodiments the loaded components may include a configuration generation component 228 for generating one or more configurations for tested computing device 244, as described in association with step 112 of FIG. 1.

The loaded components may further comprise configuration setting component 232 for setting test computing device 244 in accordance with a particular configuration, as described in association with step 116 of FIG. 1. It will be appreciated that configuration setting component 232 can alternatively be stored on storage device 220′ of tested computing device 244, or be combined of a collaborating components each stored the two storage devices.

Another component may be data and control flow management component 236 for handling the testing flow by generating configurations, initiating configuration setting of test computing device 244 according to a configuration, initiating execution of the program on test computing device 244, and receiving the execution results, for example in accordance with the method detailed on FIG. 1 above.

Yet another component may be user interface component 238 for receiving input from a user for example which parameters to set, and providing output to the user, for example upon which configurations the program passed or failed.

The loaded components may further comprise communication component 240 for communicating with test computing device 244 for setting configurations, instructing test computing device 244 to execute the programs, receiving execution results, or the like.

Storage device 220′ of test computing device may comprise program or configuration storage 248 for storing the program to be executed, and communication component 240′ designed to communicate with communication component 240 of computing device 200.

It will be appreciated that in some embodiments, computing device 200 and test computing device 244 may be the same computing device, such that the computing device changes its own parameters and executes the program under test. In such settings, among other necessary changes, communication components 240 and 240′ may be omitted.

It will be further appreciated that some hardware parameters which may be changed by physically adding, removing or replacing components, can be set by activating an actuator such as a robotic arm for carrying out the required setting, for example by physically adding or removing a processor, replacing memory devices, or the like.

The disclosed method and apparatus provide for automatically setting a computing platform in accordance with configurations comprising parameters, some of which may relate to hardware parameters, and testing a program on the multiplicity of settings, thus saving the burden to obtain and maintain a multiplicity of computing platforms having a multiplicity of configurations, such as hardware configurations. Using the method and apparatus, it may be sufficient for a programmer developing programs to obtain one computing platform, preferably a high-end computing platform with multiple options, such as multiple processors, large cache size, or the like, and simulate the execution of the program on multiple different configurations, thus simulating multiple computing devices.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like, conventional procedural programming languages, such as the “C” programming language or similar programming languages, scripting languages such as Perl, Python, Ruby, or any other programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
obtaining at least two configurations for a computing platform;
for each configurations of the at least two configurations:
setting the computing platform in accordance with the configuration; and
executing a computer program on the computing platform using the configuration,
thereby testing the computer program for correct execution by various computerized apparatuses.

2. The computer-implemented method of claim 1, further comprising stopping said setting and executing if a stopping criterion has been met.

3. The computer-implemented method of claim 2, wherein the stopping criterion is selected from the group consisting of: the computer program has been executed with respect to the at least two configurations; a maximal number of executions has been reached; and a maximal duration of execution time has been reached.

4. The computer-implemented method of claim 2 wherein the stopping criterion is that an error has been discovered with respect to an execution.

5. The computer-implemented method of claim 1, wherein each configuration is associated with at least one parameter of the computing platform.

6. The computer-implemented method of claim 5, wherein the at least one parameter is a hardware parameter, and wherein the computing platform may be automatically configured to modify the hardware parameter.

7. The computer-implemented method of claim 5, wherein the at least one parameter is selected from the group consisting of: number of processors;
number of threads per processor; priority of a thread; enabling or disabling automatic pre-fetching; cache size; and page size.

8. The computer-implemented method of claim 1, wherein setting the computing platform in accordance with the configuration comprises an action selected from the group consisting of: setting a registry entry; setting an environment variable; and locking caches lines.

9. The computer-implemented method of claim 1, wherein setting the computing platform in accordance with the configuration comprises executing computer instructions.

10. The computer-implemented method of claim 1, wherein setting the computing platform in accordance with the configuration comprises physically adding, removing or replacing a component of the computing platform.

11. An apparatus having a processing unit and a storage device, the apparatus comprising:
a configuration generation component for determining at least two configurations for a computing platform;
a configuration setting component for setting the computing platform in accordance with one configuration of the at least two configurations; and
a data and control flow management component for initiating setting the computing platform in accordance with the one configuration, and initiating execution of a computer program on the computing platform using the one configuration, thereby testing the computer program for correct execution by various computerized apparatuses.

12. The apparatus of claim 11, wherein the data and control flow management component repeats the setting and executing for a multiplicity of the at least two configurations.

13. The apparatus of claim 12, wherein the data and control flow management component stops repeating if a stopping criterion has been met.

14. The apparatus of claim 13, wherein the stopping criterion is selected from the group consisting of: the computer program has been executed for all of the at least one configuration; a maximal number of executions has been reached; and a maximal duration of execution time has been reached.

15. The apparatus of claim 13, wherein the stopping criterion is that an error has been discovered with respect to an execution.

16. The apparatus of claim 11, wherein the at least one configuration is associated with at least one parameter of the computing platform.

17. The apparatus of claim 16, wherein the at least one parameter is a hardware parameter, and wherein the computing platform may be automatically configured to modify the hardware parameter.

18. The apparatus of claim 16, wherein the at least one parameter is selected from the group consisting of: number of processors; number of threads per processor; priority of a thread; enabling or disabling automatic pre-fetching; cache size; and page size.

19. The apparatus of claim 11, wherein setting the computing platform in accordance with the at least one configuration comprises an action selected from the group consisting of: setting a registry entry; setting an environment variable; and locking caches lines.

20. The apparatus of claim 11, wherein setting the computing platform in accordance with the at least one configuration comprises executing computer instructions.

21. The apparatus of claim 11, further comprising an actuator for physically adding, removing or replacing a component of the computing platform.

22. A computer program product comprising:
a non-transitory computer readable medium;
a first program instruction for obtaining at least two configurations for a computing platform;
a second program instruction for setting the computing platform in accordance with each configurations of the at least two configurations;
a third program instruction for executing a computer program on the computing platform using the configuration, thereby testing the computer program for correct execution by various computerized apparatuses, wherein said first, second, third and fourth program instructions are stored on said non-transitory computer readable medium.
